(19) United States
(12) Patent Application Publication
(10) Pub. No.: US 2008/0143472 A1
(43) Pub. Date: Jun. 19, 2008

(54) Fuse structure integrated in semiconductor device

(75) Inventors: Ghil-Geun Oh, Yongin-si (KR); Jae-Hyun Ryu, Yongin-si (KR); Jae-Cheol Hwang, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/002,225

(22) Filed: Dec. 13, 2007

(30) Foreign Application Priority Data
Dec. 13, 2006 (KR) 10-2006-0127360

(51) Int. Cl. H01H 85/12

(52) U.S. Cl. 337/293

(57) ABSTRACT

A fuse structure of a semiconductor device includes a fuse pattern having a contact portions at opposite ends of the fuse pattern, wherein the fuse pattern includes a first conductive layer and a second conductive layer stacked sequentially, and a first electrode and a second electrode connected to the contact portions respectively. The fuse pattern is configured to be electrically shorted during a fuse program operation. A bottleneck portion can be formed at the center of the fuse pattern spaced apart from pad portions formed at opposite ends of the fuse pattern to which an electrode is connected, enabling breakage of the fuse pattern to be spaced apart from a contact portion of the electrode. As a result, a profile of a portion broken after a fuse program operation is improved and leakage current caused by a poor profile is suppressed.

### CROSS-REFERENCE TO RELATED APPLICATIONS

This U.S. non-provisional patent application claims priority under 35 U.S.C § 119 to Korean Patent Application 10-2006-0127360 filed on Dec. 13, 2006, the entirety of which is hereby incorporated by reference.

### BACKGROUND

The present invention relates to semiconductor devices and, more particularly, to a fuse structure integrated in a semiconductor device.

A semiconductor device is required for converting a path of an electrical signal to replace a defective circuit with a normal circuit or blocking a specific circuit from an input signal to protect stored data. In order to meet the requirement, a fuse formed at a circuit is shorted to convert a signal path.

Generally, fuse structures can be classified into a laser fuse structure in which a fuse is cut by laser beam and an electrical fuse structure in which resistance varies with strong current. When a laser beam of high energy is irradiated to a laser beam structure, a fuse is completely cut to block a signal path. Meanwhile, in an electrical fuse structure, resistance varying with strong current is used to logically block a circuit.

FIG. 1A is a top plan view of a conventional electrical fuse structure, and FIG. 1B is a cross-sectional view taken along the line I-I′ of FIG. 1.

Referring to FIGS. 1A and 1B, a conventional electrical fuse structure includes a first conductive layer 10 and a second conductive layer 12 disposed on the first conductive layer 10. The first conductive layer 10 is made of a material having higher resistance than the second conductive layer 12. Generally, the first conductive layer 10 is made of polysilicon and the second conductive layer 12 is made of silicide. Opposite ends of the second conductive layer 12 have contact portions to which interconnections 14a and 14b are connected, respectively.

Before programming a fuse, current between the first and second interconnections 14a and 14b flows through the second conductive layer 12. Accordingly, a value of current passing the fuse has a first level.

FIGS. 2A and 2B illustrate a fuse structure after programming a fuse.

Referring to FIGS. 2A and 2B, program current flows through the first and second interconnections 14a and 14b when a fuse is programmed. The second conductive layer 12 is cut by the current flowing to the second conductive layer 12 to be open.

In a conventional fuse structure, a second conductive layer 12 of a fuse has higher resistance than an interconnection. Therefore, Joule's heat is generated in the vicinity of an interconnection-coupled portion due to rapid increase of current to cut the second conductive layer 12. Since a shorted portion is blocked from a current path after programming the fuse, current flows through the first conductive layer 10. Accordingly, a difference between resistances of the first and second conductive layers 10 and 12 results in a difference between pre-programmed fuse current I1 (FIG. 1B) and post-programmed fuse current I2 (FIG. 2B). Further, a value of the current passing the fuse has a second level lower than the first level.

As described above, in a conventional fuse structure, current flows even after programming a fuse. For this reason, needed is a logic circuit configured for comparing a pre-programmed fuse current level with a post-programmed fuse current level to logically block a signal path. Moreover, the fuse is broken at a portion 12a adjacent to an interconnection to make a post-program fuse pattern profile poor. Thus, leakage current increases.

### SUMMARY OF THE INVENTION

Aspects of the present invention are directed to a fuse structure of a semiconductor device.

In accordance with one aspect of the present invention, the fuse structure includes: a fuse pattern having a first contact portion and a second contact portion, wherein the fuse pattern including a first conductive layer and a second conductive layer stacked sequentially and configured to both be electrically shorted during a fuse program operation; and a first electrode and a second electrode connected to the first and second contact portions respectively.

The first conductive layer can be configured to be cut after the second conductive later, during the fuse program operation.

The fuse pattern can include a linear portion between the contact portions, and the linear portion can include a bottleneck portion at the center of the linear portion, the bottleneck portion having a width smaller than the width of other portions of the linear portion.

The bottleneck portion can include an opening where the second conductive layer is cut to expose the first conductive layer.

The bottleneck portion can comprise a transition region where a width of the linear portion decreases to the smaller width suddenly.

The width of the other portions of the linear portion can be at least two times larger than the smaller width of the bottleneck portion.

The bottleneck portion can comprise a transition region where a width of the linear portion decreases to the smaller width gradually.

The smaller width of the bottleneck portion can be at least larger than half of the width of the other portions of the linear portion.

The bottleneck portion can include an opening where the second conductive layer is shorted to expose the first conductive layer.

The fuse pattern can be configured to be electrically shorted at the bottleneck portion during the fuse program operation.

The first and second conductive layers of the bottleneck portion can be configured to be cut during the fuse program operation.

The second conductive layer can have a lower resistance than the first conductive layer.

The first conductive layer can include polysilicon, and the second conductive layer can include silicide.

In accordance with another aspect of the present invention, there is provided a fuse structure of a semiconductor device, comprising: a fuse pattern having a first contact portion and a second contact portion with an interposed linear portion that includes a bottleneck portion having a width smaller than a width of other portions of the linear portion, the fuse pattern including a first conductive layer and a second conductive layer stacked sequentially and configured to both be shorted at the bottleneck portion during a fuse program operation; and a first electrode and a second electrode connected to the first and second contact portions respectively.

The bottleneck portion can comprise a transition region where a width of the linear portion decreases to the smaller width suddenly.

The width of the other portions of the linear portion can be at least two times larger than the smaller width of the bottleneck portion.

The bottleneck portion can comprise a transition region where a width of the linear portion decreases to the smaller width gradually.

The smaller width of the bottleneck portion can be at least larger than half of the width of the other portions of the linear portion.

The second conductive layer can have a lower resistance than the first conductive layer.

The first conductive layer can include polysilicon, and the second conductive layer can include silicide.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention.

FIGS. 1A and 1B are a top plan view and a cross-sectional view of a conventional fuse structure, respectively.

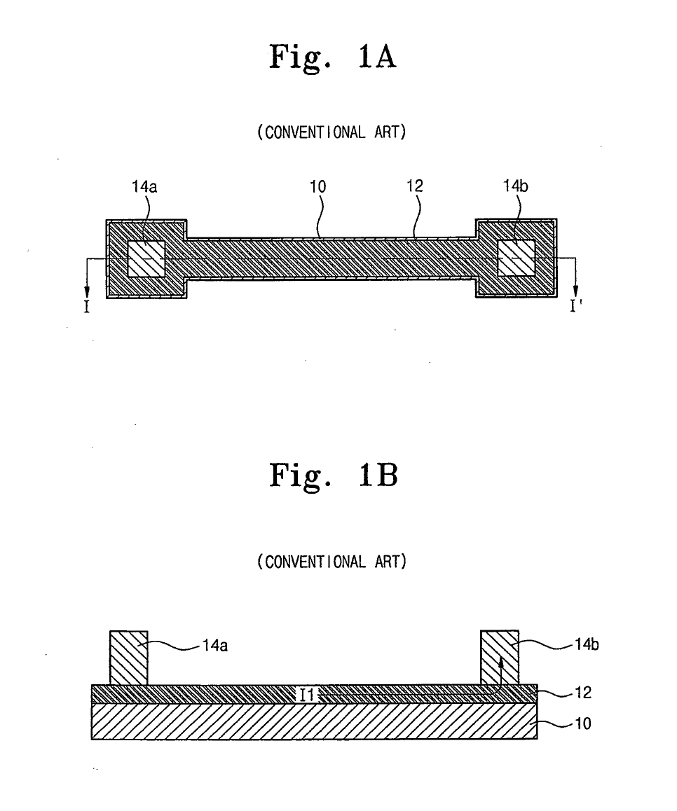

FIGS. 2A and 2B are a top plan view and a cross-sectional view of a conventional fuse structure after a fuse program operation.

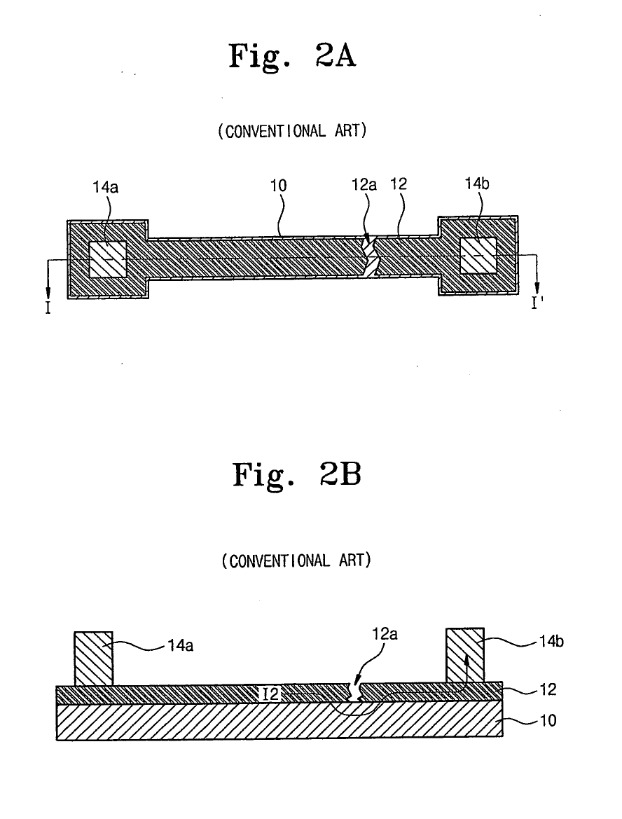

FIGS. 3A and 3B are a top plan view and a cross-sectional view of a first embodiment of a fuse structure according to an aspect of the present invention, respectively.

FIGS. 4A and 4B are a top plan view and a cross-sectional view of a second embodiment of a fuse structure according to an aspect of the present invention, respectively.

FIGS. 5A and 5B are plane views of fuse structures in accordance with the first and second embodiments of FIGS. 3A and 3B and FIGS. 4A and 4B, respectively.

FIG. 6 is a sectional view of an embodiment of a post-programmed fuse structure according to aspects of the present invention.

FIG. 7 is an exemplary embodiment of an equivalent circuit diagram of an input/output circuit according to aspects of the present invention.

### DETAILED DESCRIPTION OF PREFERRED EMBODIMENTS

Hereinafter, aspects of the present invention will be described by explaining illustrative embodiments in accordance therewith, with reference to the attached drawings. This invention, however, can be embodied in many different forms and should not be construed as limited to the embodiments set forth herein. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

In the drawings, the thicknesses of layers and regions are exaggerated for clarity. It will also be understood that when a layer is referred to as being “on” another layer or substrate, it can be directly on the other layer or substrate, or intervening layers can also be present. Like numbers refer to like elements throughout.

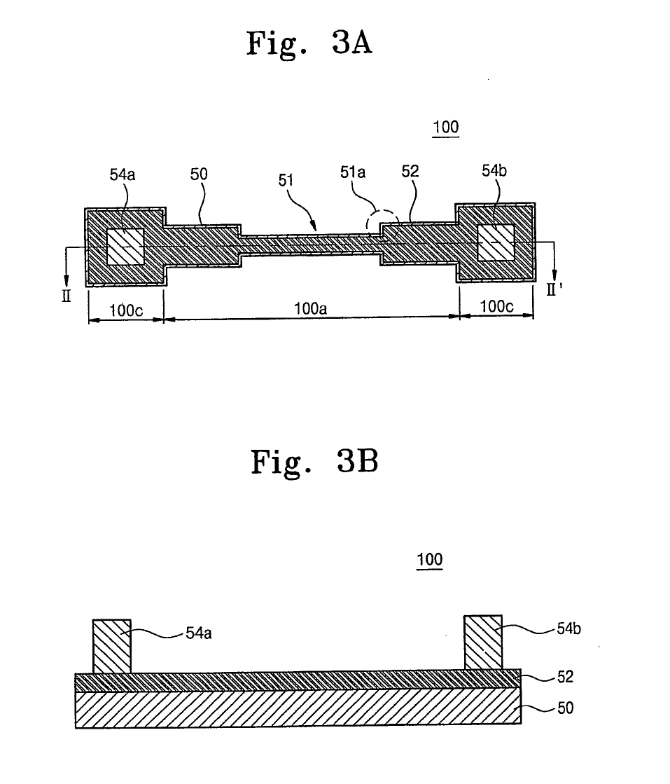

FIG. 3A is a top plan view of a first embodiment of a fuse structure 100 according to a first aspect of the present invention, and FIG. 3B is a cross-sectional view taken along the line II-II′ of FIG. 3A.

Referring to FIGS. 3A and 3B, the fuse structure 100 includes a fuse pattern in which a first conductive layer 50 and a second conductive layer 52 are stacked in the order listed. The fuse pattern can include contact portions 100c disposed at opposite ends of the fuse pattern and a linear portion 100a between the contact portions 100c. A first electrode 54a and a second electrode 54b are connected to the contact portions 100c, respectively.

The first conductive layer 50 can be made of a material having a higher resistance than that of the second conductive layer 52. For example, the first conductive layer 50 can be made of polysilicon and the second conductive layer 52 can be made of silicide.

Generally, a gate electrode of a transistor has a structure in which a polysilicon layer and a silicide layer are sequentially stacked on an insulating layer. Accordingly, the fuse pattern can have the same stacked structure as a gate electrode and can be formed concurrently with the gate electrode.

In accordance with the present invention, the fuse pattern is characterized in that not only the second conductive layer 52, but also the first conductive layer 50, is configured to be broken during a fuse program operation. Thus, the fuse pattern includes a bottleneck portion 51 where Joule's heat is concentrated by increasing sheet resistance of the fuse pattern. The linear portion 100a has a smaller width than that of the contact portions 100c. The bottleneck portion 51 having a small width can be formed at the center of the linear portion 100a.

In the first embodiment, the bottleneck portion 51 can have a transition region formed by suddenly decreasing a width of the linear portion 100a, as shown at a part “51a”. In the embodiment of FIG. 3A, the transition region may form a substantially 90 degree angle. Further, it is proper to maximize the sheet resistance by forming the bottleneck portion 51 to have smaller width than about half of the width of the liner portion 100a, in this embodiment.

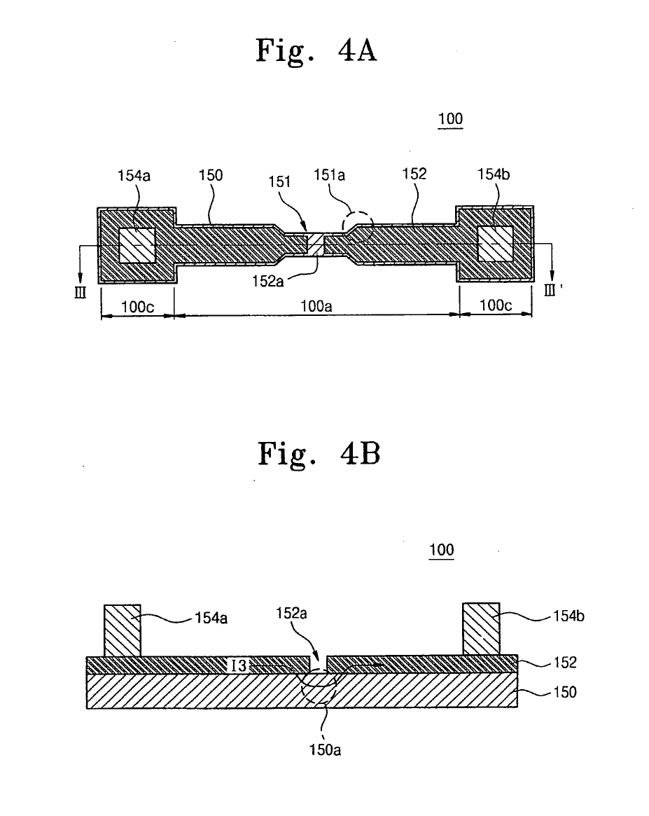

FIG. 4A is a top plan view of a second embodiment of a fuse structure 100′ according to another aspect of the present invention, FIG. 4B is a cross-sectional view taken along the line III-III′ of FIG. 4A.

Referring to FIGS. 4A and 4B, similar to the first embodiment, the fuse structure 100′ includes a fuse pattern including pad portions 100c and a linear portion 100a, and a first electrode 154a and a second electrode 154b connected to opposite ends of the fuse pattern. The pad portions 100c are formed at the opposite ends of the fuse pattern respectively, and the linear portion 100a is disposed between the pad portions 100c.

The fuse pattern has a structure in which a first conductive layer 150 and a second conductive layer 152 stacked in the order listed. The first conductive layer 150 can be made of a material having a lower resistance than that of the second conductive layer 152. For example, the fuse pattern has the same structure as a gate electrode. In other words, the first conductive layer 150 can be made of polysilicon and the second conductive layer 152 can be made of silicide.

In the second embodiment, a portion of the second conductive layer 152 is cut to form an opening 152a exposing the first conductive layer 150. The fuse pattern is characterized in that not only the second conductive layer 152, but also the first conductive layer 150, is configured to be broken during a fuse program operation. Thus, the fuse pattern includes a bottleneck portion 151 where sheet resistance increases so that Joule's heat is concentrated. The linear portion 100a has a smaller width than that of the contact portion 100c. The bottleneck portion 151 having a small width can be formed at the center of the linear portion 100a, as in this embodiment.

In the second embodiment, the bottleneck portion 151 can have a transition region that gradually tapers. That is, the width of the linear portion 100a decreases gradually, as shown at a portion “151a”, and then transitions to a constant width to form the bottleneck portion 151. The rate of the taper can be substantially constant in the transition region. The width of the bottleneck portion 151 is larger than about half of the width of the linear portion 100a to increase the amount of current flowing through the fuse pattern before a fuse program operation.

The opening 152a is formed at the bottleneck portion 151 during the fuse program operation. As a result, also during the fuse program operation, program current I3 can flow through the first conductive layer 150 having high resistance at the bottleneck portion 151. Thus, Joule's heat is concentrated at the first conductive layer 150a exposed to the opening 152a, which can cause the first conductive layer 150 to also be broken, even though the fuse pattern has a relatively wide width at the bottleneck portion 151.

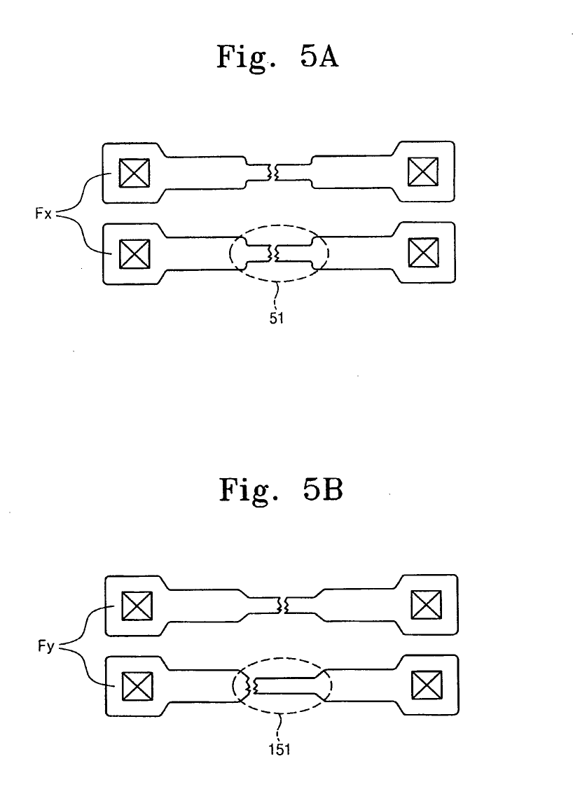

FIGS. 5A and 5B are plane views of fuse structures in accordance with the first and second embodiments of FIGS. 3A and 3B and FIGS. 4A and 4B, respectively.

As shown in FIGS. 5A and 5B, after a fuse program operation, fuse structures according to the present invention are broken at bottleneck portions 51 (FIGS. 3A and 3B) and 151 (FIGS. 4A and 4B) of fuse patterns Fx and Fy so that they are electrically shorted, respectively.

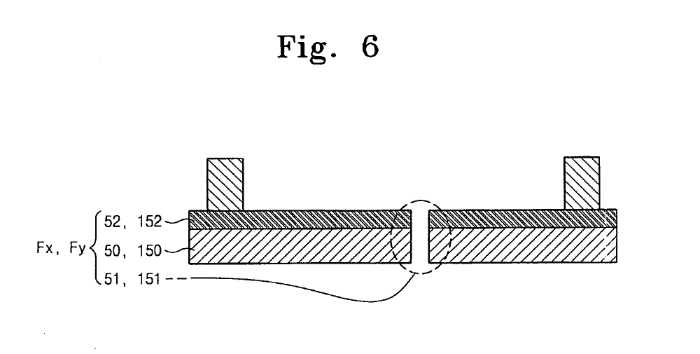

FIG. 6 is a sectional view of a post-programmed fuse structure in accordance with the first and second embodiments of FIGS. 3A and 3B and FIGS. 4A and 4B, respectively. As illustrated in FIG. 6, the fuse patterns Fx and Fy are electrically shorted because first conductive layers 50 and 150 and second conductive layers 52 and 152 are all broken.

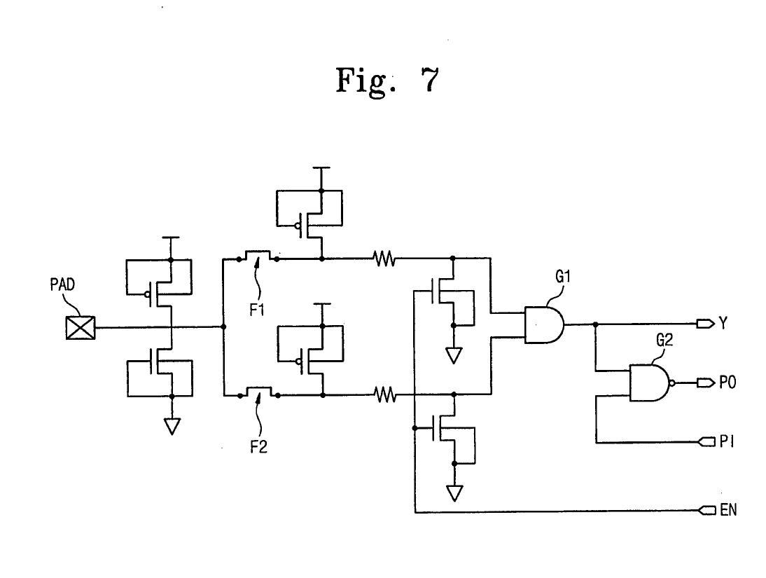

FIG. 7 is an embodiment of an exemplary equivalent circuit diagram of an input/output circuit according to an aspect of the present invention.

Referring to FIG. 7, a fuse pattern according to this embodiment can be used to protect input data after the data is input to a semiconductor device. An output signal Y of a first gate G1 is generated in response to an input signal at a pad PAD before a fuse program operation. In this state, data is stored in a semiconductor device.

During the fuse program operation, a program start signal EN is input, thus fuses F1 and F2 are broken to program a fuse. Since the fuses F1 and F2 according to aspects of the present invention can each block a signal path, it is not necessary to add a circuit for judging whether the signal path is turned on/off. When the fuses F1 and F2 are blocked, the output signal Y of the first gate G1 is maintained at a low level irrespective of the input signal of the pad PAD. Since input/output terminal which is fuse-programmed is not usable, it is impossible to access to the semiconductor device from the outside, i.e., externally. As a result, the data stored in the semiconductor device can be protected.

According to the present invention, a fuse pattern is electrically shorted during a fuse program operation to block a signal path. A bottleneck portion is formed at the center of the fuse pattern spaced apart from pad portions formed at opposite ends of the fuse pattern to which an electrode is connected, enabling breakage of the fuse pattern to be spaced apart from a contact portion of the electrode. As a result, after a fuse program operation, a profile of a portion broken is improved and leakage current caused by a poor profile is suppressed.

In addition, a bottleneck portion having a smaller width than a linear portion is formed at the linear portion having a smaller width than a pad portion. Thus, Joule's heat is concentrated at the bottleneck portion to break a fuse at the bottleneck portion. A second metal layer having lower resistance than a first metal layer is cut at the bottleneck portion. Thus, Joule's heat is concentrated at the first metal layer of the bottleneck portion to electrically short the fuse pattern.

Moreover, since a fuse structure includes a fuse pattern which is itself capable of blocking a signal path, it is not necessary to add a circuit for comparing pre-programmed fuse resistance and post-programmed fuse resistance with each other to block a signal path.

Although the present invention has been described in connection with the above exemplary embodiments illustrated in the accompanying drawings, it is not limited thereto. It will be apparent to those skilled in the art that various substitutions, modifications and changes can be made without departing from the scope and spirit of the invention. It is intended by the following claims to claim that which is literally described and all equivalents thereto, including all modifications and variations that fall within the scope of each claim.

What is claimed is:

1. A fuse structure of a semiconductor device, comprising:
a fuse pattern having a first contact portion and a second contact portion, the fuse pattern including a first conductive layer and a second conductive layer stacked sequentially and configured to both be electrically shorted during a fuse program operation; and
a first electrode and a second electrode connected to the first and second contact portions respectively.

2. The fuse structure of claim 1, wherein the first conductive layer is configured to be cut after the second conductive later, during the fuse program operation.

3. The fuse structure of claim 1, wherein the fuse pattern includes a linear portion between the contact portions, and the linear portion includes a bottleneck portion at the center of the linear portion, the bottleneck portion having a width smaller than the width of other portions of the linear portion.

4. The fuse structure of claim 3, wherein the bottleneck portion includes an opening where the second conductive layer is cut to expose the first conductive layer.

5. The fuse structure of claim 3, wherein the bottleneck portion comprises a transition region where a width of the linear portion decreases to the smaller width suddenly.

6. The fuse structure of claim 5, wherein the width of the other portions of the linear portion is at least two times larger than the smaller width of the bottleneck portion.

7. The fuse structure of claim 3, wherein the bottleneck portion comprises a transition region where a width of the linear portion decreases to the smaller width gradually.

8. The fuse structure of claim 7, wherein the smaller width of the bottleneck portion is at least larger than half of the width of the other portions of the linear portion.

9. The fuse structure of claim 7, wherein the bottleneck portion includes an opening where the second conductive layer is shorted to expose the first conductive layer.

10. The fuse structure of claim 3, wherein the fuse pattern is configured to be electrically shorted at the bottleneck portion during the fuse program operation.

11. The fuse structure of claim 3, wherein the first and second conductive layers of the bottleneck portion are configured to be cut during the fuse program operation.

12. The fuse structure of claim 1, wherein the second conductive layer has a lower resistance than the first conductive layer.

13. The fuse structure of claim 12, wherein the first conductive layer includes polysilicon, and the second conductive layer includes silicide.

14. A fuse structure of a semiconductor device, comprising:
a fuse pattern having a first contact portion and a second contact portion with an interposed linear portion that includes a bottleneck portion having a width smaller than a width of other portions of the linear portion, the fuse pattern including a first conductive layer and a second conductive layer stacked sequentially and configured to both be shorted at the bottleneck portion during a fuse program operation; and
a first electrode and a second electrode connected to the first and second contact portions respectively.

15. The fuse structure of claim 14, wherein the bottleneck portion comprises a transition region where a width of the linear portion decreases to the smaller width suddenly.

16. The fuse structure of claim 15, wherein the width of the other portions of the linear portion is at least two times larger than the smaller width of the bottleneck portion.

17. The fuse structure of claim 14, wherein the bottleneck portion comprises a transition region where a width of the linear portion decreases to the smaller width gradually.

18. The fuse structure of claim 17, wherein the smaller width of the bottleneck portion is at least larger than half of the width of the other portions of the linear portion.

19. The fuse structure of claim 14, wherein the second conductive layer has a lower resistance than the first conductive layer.

20. The fuse structure of claim 14, wherein the first conductive layer includes polysilicon, and the second conductive layer includes silicide.
